(19) United States
(12) Patent Application Publication
(10) Pub. No.: US 2011/0133041 A1
(43) Pub. Date: Jun. 9, 2011

(54) TOOTHBRUSH IGLOO SYSTEM

(76) Inventors: Lucinda W. Rodriguez, Metairie, LA (US); Ralph J. Rodriguez, Metairie, LA (US)

(21) Appl. No.: 12/946,729

(22) Filed: Nov. 15, 2010

Related U.S. Application Data
(60) Provisional application No. 61/266,533, filed on Dec. 4, 2009.

(51) Int. Cl. A46B 17/08; F16B 47/00; B23P 17/04

(52) U.S. Cl. 248/111; 29/428

(57) ABSTRACT

Toothbrush Igloo is an igloo-shaped device with an animal caricature on the top that holds a toothbrush in an horizontal position that allows users to easily apply toothpaste without requiring assistance. Users can store their toothbrushes and toothpaste in the rear compartment of the holder in between uses. When preparing to brush their teeth, users can place the handle of their brush into the horizontal opening that will secure the bristle end of the brush in an upright position, allowing for an easy toothpaste application. There may be small suction cups or other non-slip materials located on the device providing for secure placement on several locations. There may be an internal dividing wall between the rear compartment and front horizontal holder to prevent the toothbrush from being pushed too far back. The front holder is lined with rubber providing a more stable hold. During non-brushing periods the toothpaste dispenser and toothbrushes may be vertically stored.

### CROSS-REFERENCE TO RELATED APPLICATION

The present application is related to and claims priority from prior provisional application Ser. No. 61/266,533, filed Dec. 4, 2009 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of holders and more specifically relates to a hands-free toothbrush holder permitting a user to easily apply toothpaste without requiring assistance.

2. Description of the Related Art

A variety of oral hygiene measures have been used since before recorded history. This has been verified by various excavations done all over the world, in which chewsticks, tree twigs, bird feathers, animal bones and porcupine quills were recovered. The first toothbrush recorded in history was made in about 3000 BC, a twig with a frayed end called a chewstick. Since then toothbrushes as we now know them have evolved.

The toothbrush is an oral hygiene instrument used to clean the teeth and gums that is typically comprised of a head of tightly clustered bristles mounted on a handle, which facilitates the cleansing of hard-to-reach areas of the mouth. Toothbrushes are available with different bristle textures, sizes and forms. Most dentists recommend using a toothbrush labelled “soft”, since firmer bristled toothbrushes can damage tooth enamel and irritate the gums. Toothbrushes have been made from synthetic fibers in recent years, although animal bristles are still sometimes used.

Toothpaste is a paste or gel dentifrice used with a toothbrush as a means to clean and maintain the aesthetics and health of teeth. Toothpaste is used to promote oral hygiene: it acts as an abrasive that aids in removing the dental plaque and food from the teeth, assists in the elimination and/or masking of halitosis, and delivers active ingredients such as fluoride or xylitol to help prevent tooth and gum disease (gingivitis). Toothpaste, which often contains fluoride, is commonly used in conjunction with a toothbrush to increase the effectiveness of teeth brushing.

The simple task of brushing one's teeth and applying toothpaste to a toothbrush is taken for granted by a significant amount of the population. However, these tasks may pose a physical challenge for young children, elderly users, or individuals with physical limitations to use both hands to apply toothpaste to a toothbrush. Users may set the toothbrush on a countertop to hold it while they apply toothpaste, but it is easy for the brush to fall over, become contaminated and pose frustration for the user. Many individuals prefer to be as independent as possible when it comes to daily hygiene and so it can be frustrating to have to ask for help when brushing their teeth.

A toothbrush holder may commonly include a vertically-oriented temporary holding device of a toothbrush and sometimes contains a toothpaste dispenser. The toothbrush holder traditionally includes a plurality of openings through which the handle end of a toothbrush is inserted for storage. Toothbrush holders currently available on the market are designed to hold the brush vertically, not horizontally and thus cannot be effectively used for assistance in applying toothpaste. Therefore, a need exists for a hands-free toothbrush holder that will temporarily secure a toothbrush handle while a user is applying toothpaste to the bristles on a the toothbrush.

Various attempts have been made to solve the above-mentioned problems such as those found in U.S. Pat. Nos. 6,622,978; 2004/0163979; 6,907,638; 5,769,245; 4,955,567; 4,234,087. This prior art is representative of toothbrush holders. None of the above inventions and patents, taken either singly or in combination, is seen to describe the invention as claimed.

Ideally, a toothbrush holder that holds a toothbrush in an horizontal position permitting a user to easily apply toothpaste without requiring assistance should be convenient and user-friendly and yet, would operate reliably and be manufactured at a modest expense. Thus, a need exists for a reliable toothbrush igloo system to hold a toothbrush in an horizontal position while a user applies toothpaste to avoid the above-mentioned problems.

### BRIEF SUMMARY OF THE INVENTION

In view of the foregoing disadvantages inherent in the known toothbrush holding device art, the present invention provides a novel toothbrush igloo system. The general purpose of the present invention, which will be described subsequently in greater detail is to assist children, the elderly, or those with limited mobility in their arms or hands apply toothpaste onto a toothbrush. Users simply place the handle of their toothbrush into the horizontal holder and then apply the toothpaste to the bristles. The rubber-lined holder will prevent the brush from falling over. This attractive item is designed to help people be more independent with their personal hygiene and may be available in an assortment of designs suitable for personal use, hospitals, senior care facilities or other locations. It can also be used to teach children how to brush their own teeth, as they will no longer need to ask for assistance from parents or care-givers.

The present hands-free mountable toothbrush holding device for dispensing toothpaste system disclosed herein preferably comprises the following components: a housing; a base; a rear storage compartment; a front-facing slot with a horizontal brush holder; an internal dividing wall; and an animal caricature for aesthetic enhancement.

The housing is supported by the base. Further, the housing comprises the rear storage compartment and the front-facing slot. The rear storage compartment stores a toothpaste dispenser and at least one toothbrush during a non-use period. The front-facing slot with a horizontal brush holder is lined with a rubber gripping material to provide a grippingly-stable hold for the toothbrush to prevent movement during the toothpaste applying session(s). The internal dividing wall is preferably located between the rear storage compartment and the front-facing horizontal holder.

The front-facing slot allows for the temporary securing of a handle of the toothbrush allowing the toothpaste to be dispensed on bristles of the toothbrush in a hands-free mode. The internal dividing wall acts to prevent the toothbrush from being pushed back past a specified pre-determined insert-distance. The animal caricature is located on a top surface of the hands-free mountable toothbrush holding device such that a child may be enticed to brush his/her teeth.

A kit is also embodied herein for the toothbrush system comprising: a hands-free mountable toothbrush holding device; at least one suction cup; at least one toothbrush; an insertable toothpaste dispenser; and a set of user instructions.

In accordance with the embodiments of the present invention a preferred method of use is disclosed herein comprising: mounting the toothbrush igloo systems onto a surface; inserting a handle of a toothbrush into a front-facing slot within the housing; dispensing toothpaste from the toothpaste tube (toothpaste dispenser) onto bristles of the toothbrush; removing the toothbrush from the front-facing slot; a user grasping the handle of the toothbrush and initiating the brushing of teeth of the user; and optionally storing the toothbrush and/or toothpaste dispenser in the rear storage compartment once the user is finished brushing his/her teeth.

The present invention holds significant improvements and serves as a toothbrush igloo system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, toothbrush igloo system device constructed and operative according to the teachings of the present invention.

FIG. 1 shows a toothbrush igloo system in an ‘in-use’ condition according to an embodiment of the present invention.

FIG. 2 shows a perspective view illustrating a hands-free mountable toothbrush holding device of the toothbrush igloo system according to an embodiment of the present invention.

FIG. 3 shows perspective views illustrating an animal caricature of the toothbrush igloo system according to embodiments of the present invention of FIG. 1.

FIG. 4 is a perspective view illustrating the hands-free mountable toothbrush holding device of the toothbrush igloo system removably attached to a bathroom sink according to an embodiment of the present invention of FIG. 1.

FIG. 5 is a perspective view illustrating a plurality of attachers located on the posterior of the hands-free mountable toothbrush holding device of the toothbrush igloo system according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a holder and more specifically relates to a toothbrush holder for hands-free holding a toothbrush in a horizontal position permitting a user to easily apply toothpaste without requiring assistance.

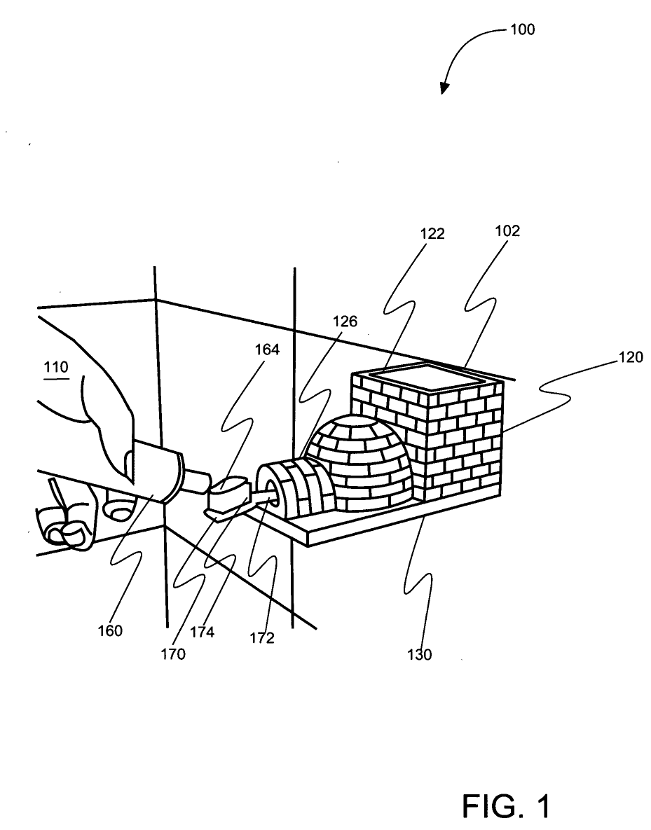

Referring now to FIGS. 1 & 2 showing perspective views of toothbrush igloo system 100 according to embodiments of the present invention. Toothbrush igloo system 100 comprises hands-free mountable toothbrush holding device 102. Hands-free mountable toothbrush holding device 102 may be used to assist children, the elderly, or those with limited mobility in their arms or hands apply toothpaste 164 by hand or optionally via toothpaste dispenser 160 onto bristles 174 of toothbrush 170 as shown best in ‘in-use condition’ 110 in FIG. 1. Hands-free mountable toothbrush holding device 102 preferably comprises housing 120 and base 130. Housing 120 is supported by base 130 in the present embodiment shown.

Housing further comprises rear storage compartment 122 and front-facing slot 126. Rear storage compartment 126 stores toothpaste dispenser 160 and at least one toothbrush 170 during a non-use condition. In this way the present invention serves to promote increased hygiene for its users. Front-facing slot 126 allows for the temporary securing of handle 172 of toothbrush 170 horizontally, thereby permitting toothpaste dispenser 160 (toothpaste dispenser 160 comprising toothpaste tube) to dispense toothpaste 164 onto bristles 174 of toothbrush 170 in a hands-free mode. Further, front-facing slot 126 is preferably lined with a gripping material to provide a grippingly-stable hold for toothbrush 170 when in ‘hand-free mode’. Gripping material preferably comprises rubber in a preferred embodiment. Located between rear storage compartment 122 and front-facing slot 126 in housing 120 is internal dividing wall 124. Internal dividing wall 124 preferably acts as a prevention means to deter toothbrush 170 from being pushed back past a specified insert-distance.

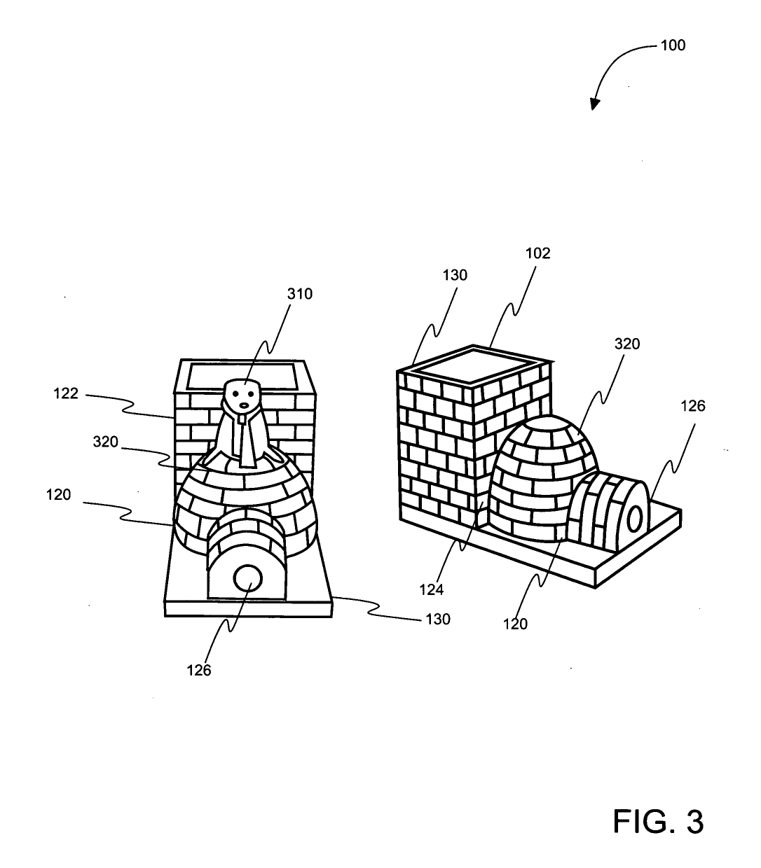

Referring now to FIG. 3 showing perspective views illustrating animal caricature 310 of toothbrush igloo system 100 according to an embodiment of the present invention of FIG. 1.

Animal caricature 310 is preferably located on top surface 320 of hands-free mountable toothbrush holding device 102. Animal caricature may comprise at least one of the following, but is not limited to these examples: a polar bear, a dog a seal, or a cat.

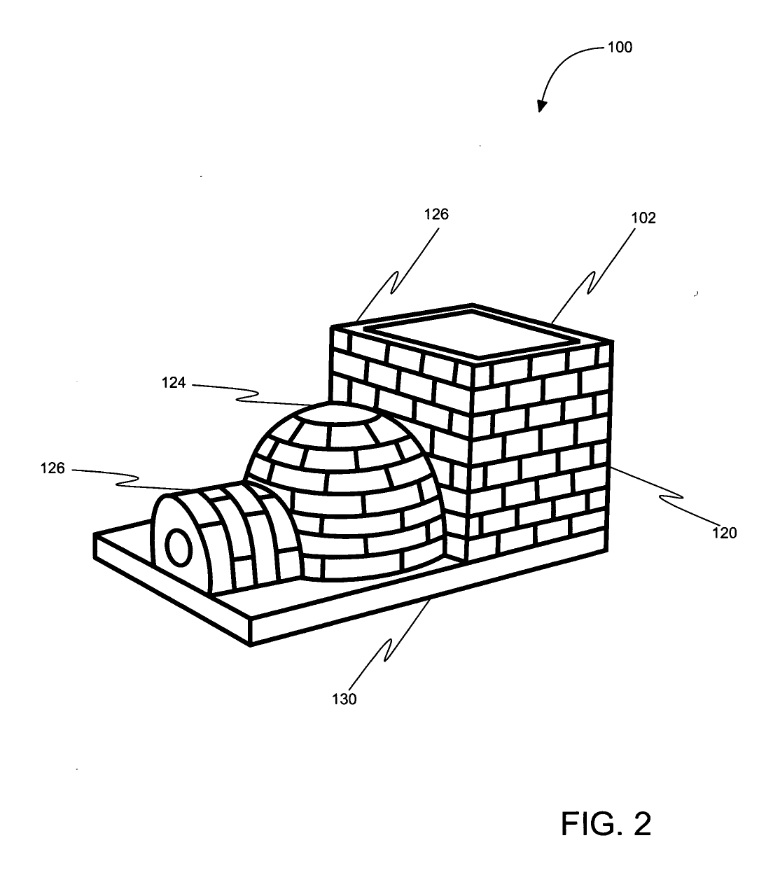

Hands-free mountable toothbrush holding device 102 for dispensing toothpaste 164 preferably is igloo-shaped resembling an igloo with detailed ice blocks as shown in FIGS. 1-5, however other designs are feasible. The igloo-shaped design may be altered into a variation that when sold, a percentage of the proceeds may go to an animal rescue operation. Additionally other design possibility may include housing 120 with rear storage compartment 122 and front-facing slot 126 minus the aesthetic igloo design. For example, rear storage compartment 122 may be in the shape of a square and in a solid color having a smooth surface while front-facing slot 126 may be rectangular shaped also comprising a solid-colored smooth surface. This variation may be ideal for hospitals, senior care facilities, orthopedic rehabilitation centers and other such institutions, thus removing potentially germ-holding horizontal edges/surfaces/ledges.

Hands-free mountable toothbrush holding device 102 is preferably manufactured from a light-weight material. This light-weight material may comprise plastic for example. Other suitable materials may be used. The dimensions of the hands-free mountable toothbrush holding device 102 measure approximately 3-inches high by 4 inches long by 3 inches wide by 3 inches deep. Toothbrush igloo system 100 may be manufactured in several different colors or designs and is not limited to an igloo shape, as previously mentioned.

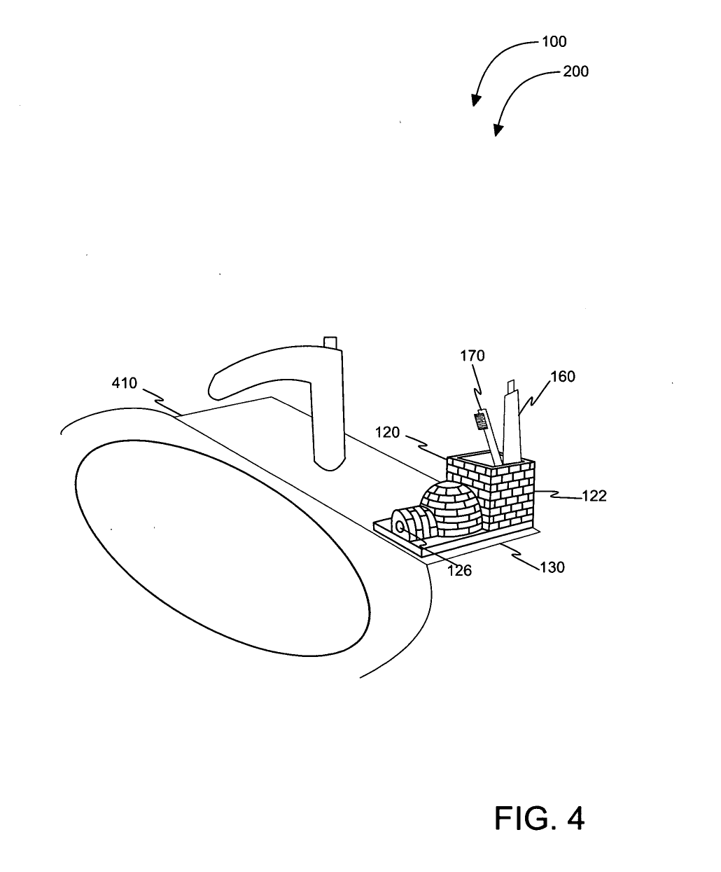

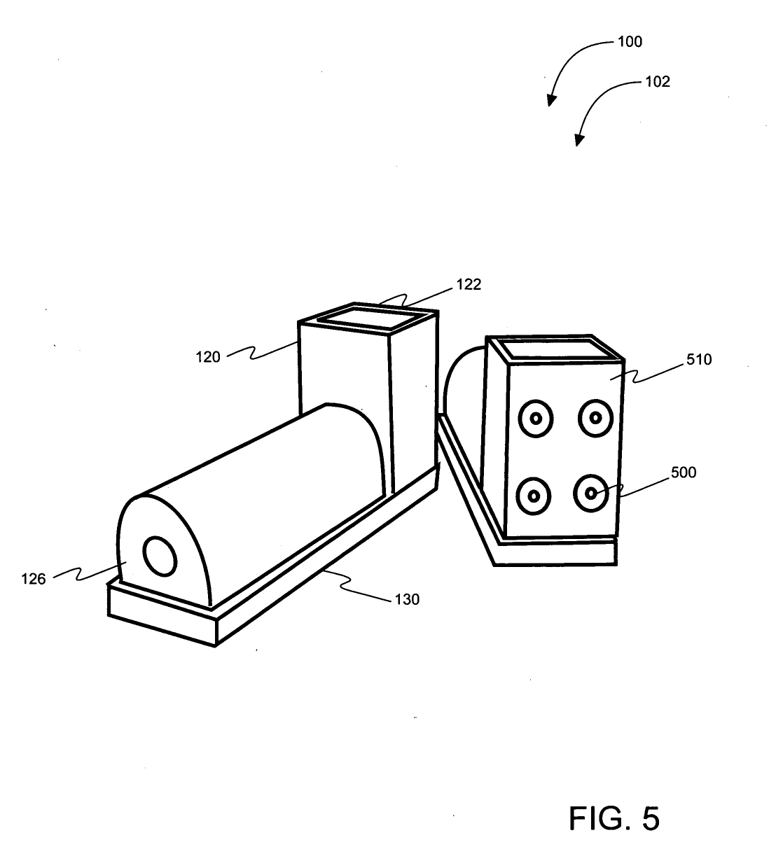

Referring now to FIGS. 4 & 5 showing perspective views of a plurality of attachers 500 removably mountable onto various locations (also alluded to in FIG. 1). Attacher(s) 500 preferably comprise non-slip material(s). Examples of non-slip material(s) may include suction cups, adhesive(s), 2-sided tape, sticky pads, and other such suitable fasteners. As shown in FIG. 5, a plurality of suction cups may be used. Further, attacher(s) 500 are preferably located on posterior side 510 of hands-free mountable toothbrush holding device 102 as also shown in FIG. 5.

Hands-free mountable toothbrush holding device 102 may be removably mountable to at least one vertical surface via attacher(s) 500 as shown in FIG. 4. The vertical surface for removably mounting hands-free mountable toothbrush holding device 102 may include a wall, mirror or other substantially horizontal and/or vertical surface(s). Hands-free mountable toothbrush holding device 102 may be removably mountable to at least one horizontal surface via (bottom-mounted) attacher(s) 500. The horizontal surface for removably mounting hands-free mountable toothbrush holding device 102 may include a bathroom fixture such as sink 410 as shown in FIG. 4. Other mounting locations may be used to removably mount hands-free mountable toothbrush holding device 102.

Toothbrush igloo system 100 according to an embodiment of the present invention of FIGS. 1-5 may comprise kit 540. Kit 540 may comprise the following parts: hands-free mountable toothbrush holding device 102; at least one suction cup; at least one toothbrush 170; an insertable toothpaste dispenser 160; and a set of user instructions.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately such as at least one (optionally removable) animal caricature, or at least one attacher, etc., may be sufficient.

A method of using hands-free mountable toothbrush holding device 102 comprising the steps of: step one mounting toothbrush igloo system 100 onto a surface; step two inserting handle 172 of toothbrush 170 into front-facing slot 126 within housing 120; step three removing toothpaste dispenser 160 from rear storage compartment 122 of housing 120; step four dispensing toothpaste 164 from toothpaste dispenser 160 onto bristles 174 of toothbrush 170; step five removing toothbrush 170 from front-facing slot 126; step six a user grasping handle 172 of toothbrush 170 and initiating the brushing of teeth of the user; and optionally step seven storing toothbrush 170 in rear storage compartment 122 once the user is finished brushing their teeth.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A hands-free mountable toothbrush holding device for dispensing toothpaste comprising:
a housing;
a base;
a rear storage compartment; and
a front-facing slot with a horizontal brush holder;
wherein said housing is supported by said base;
wherein said housing comprises said rear storage compartment and said front-facing slot;
wherein said rear storage compartment stores a toothpaste dispenser and at least one toothbrush during a non-use condition;
wherein said front-facing slot allows for the temporary securing of a handle of said toothbrush allowing said toothpaste to be dispensed on bristles of said toothbrush in a hands-free mode.

2. The hands-free mountable toothbrush holding device for dispensing toothpaste of claim 1 further comprising an internal dividing wall between said rear storage compartment and said front-facing horizontal holder to prevent said toothbrush from being pushed back past a specified insert-distance.

3. The hands-free mountable toothbrush holding device for dispensing toothpaste of claim 1 wherein said toothbrush holding device is manufactured from at least one light-weight material.

4. The hands-free mountable toothbrush holding device for dispensing toothpaste of claim 3 wherein said light-weight material is plastic.

5. The hands-free mountable toothbrush holding device for dispensing toothpaste of claim 1 wherein said hands-free mountable toothbrush holding device is removably mountable to a vertical surface.

6. The hands-free mountable toothbrush holding device for dispensing toothpaste of claim 1 wherein said hands-free mountable toothbrush holding device is removably mountable to a horizontal surface.

7. The hands-free mountable toothbrush holding device for dispensing toothpaste of claim 5 wherein said hands-free mountable toothbrush holding device is removably mountable to a wall.

8. The hands-free mountable toothbrush holding device for dispensing toothpaste of claim 6 wherein said hands-free mountable toothbrush holding device is removably mountable to a bathroom fixture.

9. The hands-free mountable toothbrush holding device for dispensing toothpaste of claim 1 wherein said hands-free mountable toothbrush holding device is removably mountable via at least one non-slip material.

10. The hands-free mountable toothbrush holding device for dispensing toothpaste of claim 9 wherein said non-slip material(s) comprises at least one suction cup.

11. The hands-free mountable toothbrush holding device for dispensing toothpaste of claim 9 wherein said non-slip material(s) comprises an adhesive.

12. The hands-free mountable toothbrush holding device for dispensing toothpaste of claim 1 wherein said hands-free mountable toothbrush holding device comprises an igloo-shape.

13. The hands-free mountable toothbrush holding device for dispensing toothpaste of claim 10 wherein said igloo-shape of said hands-free mountable toothbrush holding device further comprises an animal located on a top surface of said hands-free mountable toothbrush holding device.

14. The hands-free mountable toothbrush holding device for dispensing toothpaste of claim 13 wherein said animal comprises a polar bear.

15. The hands-free mountable toothbrush holding device for dispensing toothpaste of claim 13 wherein said animal comprises a dog.

16. The hands-free mountable toothbrush holding device for dispensing toothpaste of claim 1 wherein said front-facing slot is lined with a gripping material to provide a grippingly-stable hold for said toothbrush.

17. The hands-free mountable toothbrush holding device for dispensing toothpaste of claim 16 wherein said gripping material comprises rubber.

18. An igloo-shaped removably mountable via at least one suction cup plastic hands-free toothbrush holding device for dispensing toothpaste comprising:
a housing;
a base;
a rear storage compartment;
a front-facing slot with a horizontal brush holder lined with a rubber gripping material to provide a grippingly-stable hold for a toothbrush; and
an internal dividing wall between said rear storage compartment and said front-facing horizontal holder; and
a removable animal caricature;
wherein said housing is supported by said base;
wherein said housing comprises said rear storage compartment and said front-facing slot;
wherein said rear storage compartment stores a toothpaste dispenser and at least one said toothbrush during a non-use period;
wherein said front-facing slot allows for the temporary securing of a handle of said toothbrush allowing said toothpaste to be dispensed on bristles of said toothbrush in a hands-free mode;
wherein said internal dividing wall acts to prevent said toothbrush from being pushed back past a specified pre-determined insert-distance; and
wherein said removable animal caricature is located on a top surface of said hands-free mountable toothbrush holding device such that a child may be enticed to brush his/her teeth.

19. The hands-free mountable toothbrush holding device for dispensing toothpaste of claim 18 further comprising a kit including: said hands-free mountable toothbrush holding device; at least one suction cup fastening means; at least one toothbrush; an insertable toothpaste tube; and a set of user instructions.

20. A method of using toothbrush igloo systems comprising the steps of:
mounting said toothbrush igloo systems onto a surface;
inserting a handle of a toothbrush into a front-facing slot within a housing;
removing a toothpaste dispenser from a rear storage compartment of said housing;
dispensing toothpaste from said toothpaste dispenser onto bristles of said toothbrush;
removing said toothbrush from said front-facing slot;
a user grasping said handle of said toothbrush and initiating the brushing of teeth of said user; and
storing said toothbrush in a rear storage compartment once said user is finished brushing said teeth.
